(19) United States
(12) Patent Application Publication
(10) Pub. No.: US 2026/0018036 A1
(43) Pub. Date: Jan. 15, 2026

(54) Minimizing Unwanted Responses in Haptic Systems

(71) Applicant: Ultrahaptics IP Ltd, Bristol (GB)

(72) Inventors: Benjamin John Oliver Long, Bristol (GB); Brian Kappus, Mountain View, CA (US)

(21) Appl. No.: 19/218,309

(22) Filed: May 25, 2025

Related U.S. Application Data
(63) Continuation of application No. 18/322,779, filed on May 24, 2023, now Pat. No. 12,347,304.

(51) Int. Cl. G08B 6/00; G10K 11/34; H04R 1/40

(52) U.S. Cl. CPC G08B 6/00; G10K 11/346; H04R 1/40

(57) ABSTRACT

Disclosed are methods to manipulate a given parametrized haptic curve in order to yield a smooth phase function for each acoustic transducer which minimizes unwanted parametric audio. Further, the impulse response of a haptic system describes the behavior of the system over time and can be convolved with a given input to simulate a response to that input. To produce a specific response, a deconvolution with the impulse response is necessary to generate an input.

### RELATED APPLICATION

This application claims the benefit of two U.S. Provisional Patent Applications, each of which is incorporated by reference in its entirety:
1) Ser. No. 62/609,429, filed on Dec. 22, 2017; and
2) Ser. No. 62/777,770, filed on Dec. 11, 2018.

### FIELD OF THE DISCLOSURE

The present disclosure relates generally to improved techniques for minimizing unwanted responses in haptic feedback systems.

### BACKGROUND

A continuous distribution of sound energy, which we will refer to as an “acoustic field”, can be used for a range of applications including haptic feedback in mid-air.

Haptic curve reproduction involves the rapid translation of focal points in an ultrasonic phased array configuration in order to create a haptic sensation. Human skin is not sensitive to ultrasound frequencies alone, but can be stimulated by modulating ultrasound by a low frequency (˜100 Hz) signal. An alternative to modulation in pressure amplitude (the traditional approach) is spatiotemporal modulation-moving a focal point along a repeatable path produces a similar modulated pressure at any one point along that path to that of simple amplitude modulation. This pressure profile produces a sensation on the skin and therefore can be used for haptic feedback. This can be used to create shapes, volumes, and other haptic effects.

Because haptics from ultrasound requires large pressure amplitudes, it is susceptible to the generation of parametric audio. This is an effect whereby the nonlinearity of soundwaves in air can create audible sound. This mixing takes the form of difference tones (intermodulation distortion). For instance, if 40 kHz and 41 kHz sound waves are produced from the same transducer at sufficient amplitude, a 41−40=1 kHz tone is produced in the air and is perceivable. This is particularly easy to do with traditional amplitude modulation. For instance, modulating a 40,000 kHz by 200 Hz becomes,

$$( \text{.5} + \text{.5} cos ( 2 π * 200 t ) ) cos ( 2 π 40000 t ) = \text{.5} cos ( 2 π 40000 t ) + \text{.25} cos ( 2 π 39800 t ) + \text{.25} cos ( 2 π 40200 t ) .$$

The modulation splits the 40 kHz carrier into two side-bands at 39.8 kHz and 40.2 kHz. The resulting frequencies can mix to form 200 Hz and 400 Hz.

Spatiotemporal modulation can also lead to many side bands with large spacing which leads to intermodulation distortion at many frequencies. Moving a focal point in space requires each transducer to shift its output rapidly in phase. This can be described by,

$$output ( t ) = cos ( {ω}_{c} t + f ( t ) ) ,$$

where ω_{c} is the ultrasonic carrier frequency (2*pi*40 kHz in the previous example) and f(t) represents the phase angle. While the amplitude of the curve remains constant, changing the phase in time causes deviation from a pure tone. This comes about by expanding the function,

$$cos ( {ω}_{c} t + f ( t ) ) = cos ( f ( t ) ) cos ( {ω}_{c} t ) - sin ( f ( t ) ) sin ( {ω}_{c} t ) = cos ( {ω}_{c} t ) {\sum }_{k = 0}^{∞} \frac{{( - 1 )}^{k} {f ( t )}^{2 k}}{( 2 k ) !} - sin ( {ω}_{c} t ) {\sum }_{k = 0}^{∞} \frac{{( - 1 )}^{k} {f ( t )}^{2 k + 1}}{( 2 k + 1 ) !} .$$

In this form, it is clear that modulating the phase can wrap into sidebands related to multiple powers of the phase function. FIG. 1 is a graph 100 of an example using a pure cosine as the phase modulation function showing a frequency power spectrum of cos (ω_{c}t+2π cos (2π200t)). The x-axis 110 is frequency in kHz. The y-axis 120 is in dB. The plot 130 shows the resulting power spectrum that is the interplay of the multiple frequencies produced by increasing powers in the exponent with the decreased magnitude from the factorial denominator. The banding is spaced at 200 Hz (modulation frequency) and largely contained within 2 kHz of the 40 kHz carrier. The sidebands continue indefinitely, of course, but are beyond the precision of this simulation and at those amplitudes, unimportant.

Note that the phase functions presented here can be implemented as driving signals to transducers but also can be implemented as physical displacement. If the transducer is moved one carrier wavelength relative to others towards or away from the path, that represents a 21 phase shift, and can be interpolated in between. Smoothing methods presented here can be applied to this displacement-generated phase function equally well.

Further, high-Q resonant systems have a narrow frequency response but as a result, a long impulse response. Energy takes many cycles to leave the system and at any particular moment the current state is highly dependent on driving history. A typical solution to this problem involves using a drive amplitude (or width in the case of pulse-width-modulation (PWM)) which results in the correct steady-state result. The desired output will only be generated after sufficient cycles have elapsed related to the ring up time. While this results in the ideal solution when full amplitude is desired, headroom in the driving circuit is unused when less than full amplitude is needed.

Take, for instance, a linear system that takes 5 cycles to reach 95% steady-state value. It approaches the steady state exponentially and can reach approximately 45% of the final value in one cycle with each additional cycle yielding diminishing returns. If the desired final output is the maximum output that the system is capable of, getting there in 5 cycles is optimal. However, if the desired output is only 45% of maximum, a different solution would be to drive it at full-scale for one cycle, then cut the drive back to what would yield a steady-state result of 45% of maximum. The result is the system reaching the desired output in one cycle rather than 5. In this invention, we present methods to characterize the system and predict the necessary drive conditions to force it into an output faster than steady-state driving conditions are capable of.

### SUMMARY

Any haptic curve must be represented as a location as a function of time to be traced using an acoustic focus from a phased array. Disclosed are methods to manipulate a given parametrized curve in order to yield a smooth phase function for each transducer which minimizes unwanted parametric audio.

Further, the impulse response of a system describes the behavior of the system over time and can be convolved with a given input to simulate a response to that input. To produce a specific response, a deconvolution with the impulse response is necessary to generate an input. In a highly-resonant system the impulse response can be simplified to Fourier components at the resonant frequency which reduces deconvolution to algebra. This allows for feed-forward input generation for a desired output via linear algebra.

### BRIEF DESCRIPTION OF THE FIGURES

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIG. 1 shows a graph of a pure cosine as a phase modulation function.

FIG. 2 shows a graph of a phase modulation function with high frequency components.

FIG. 3 shows a graph of a phase function for a transducer.

FIG. 4 shows a graph of a frequency power spectrum resulting from the phase function shown in FIG. 3.

FIG. 5 shows a schematic of geometry for an arbitrary TPS curve and radius smoothing.

FIG. 6 shows a graph of applying direct radius smoothing.

FIG. 7 shows a graph of a phase function of FIG. 6.

FIG. 8 shows a graph of a frequency power spectrum of FIG. 6.

FIG. 9 shows a graph of applying temporally smooth points distributions.

FIG. 10 shows a graph of a phase function of FIG. 9.

FIG. 11 shows a graph of a frequency power spectrum of FIG. 9.

FIG. 12 shows a graph of a square curve filtered by a 2^{nd}-order Butterworth filter.

FIG. 13 shows a graph of a frequency power spectrum of FIG. 12.

FIG. 14 shows a graph of a phase function of FIG. 12.

FIG. 15 shows a graph of an example of a square with increasing orders of Fourier series expansion.

FIG. 16 shows a graph of a frequency power spectrum of FIG. 15.

FIGS. 17A and 17B show graphs of a model demonstration of a basic drive versus feed-forward control.

FIG. 18 shows graphs of amplitude and phase accuracy of amplitude-modulated input using regular and feed-forward drive.

FIG. 19 shows graphs of amplitude and phase accuracy of phase-modulated input using regular and feed-forward drive.

FIGS. 20A and 20B show graphs of cross-talk performance.

FIGS. 21A and 21B show graphs of amplitude and phase accuracy.

FIG. 22 shows a graph of simulations of a nonlinear response.

FIG. 23 shows graphs of amplitude and phase accuracy.

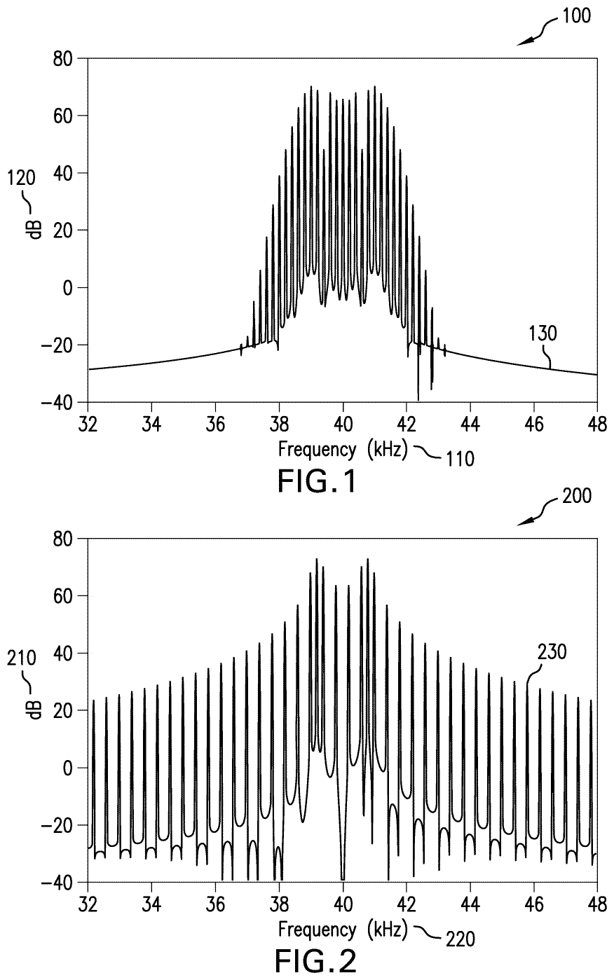

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### (1) Methods for Audio Reduction in Airborne Haptic Curves

A given curve to be traced with spatiotemporal modulation does not define a unique phase function (f(t)) solution. For instance, when tracing a line, more time could be spent on one half of the line than the other. Compared to an equal-time line this will create a different phase functions, yet the entire line is traced in both cases. On top of this, a given curve (repeated with a specific frequency) does not define a unique haptic experience. For a given carrier frequency, diffraction will limit the focusing resolution, and therefore some small deviations in the focus position can be made for a given curve and not create a discernible effect. The goal of this disclosure is to present methods with which to create a requested spatiotemporal haptic effect by adjusting the curve to be traced and the phase function(s) to trace that curve in a way which produces minimal parametric audio.

FIG. 2 is a graph 200 of an example of a phase modulation function with high frequency components. It is a frequency power spectrum of cos (ω_{c}t+2π triangle(21200t)). The x-axis 220 is frequency in kHz. The y-axis 210 is dB. As shown in the plot 230, by using a triangle wave, higher frequency harmonics are contained in every power of the modulating function and give rise to many side bands at high-frequency spacing. These then mix to make higher-frequency audio. It is interesting to note that the banding is spaced at 400 Hz instead of 200 Hz except at two small clusters around +/−800 Hz. This is due to some coincidental cancellation of various terms when using a perfect triangle wave.

Sharp features in the phase modulation function arise from sharp features in the curve being traced by the array. This includes both sharp features in space (hard angles, changes in direction) but also sharp features in time (sudden stops or starts). For instance, a common path in airborne haptics is a line parallel to the array at a fixed height. The array traces the line from one end to the other and back again at a frequency selected to maximize sensitivity.

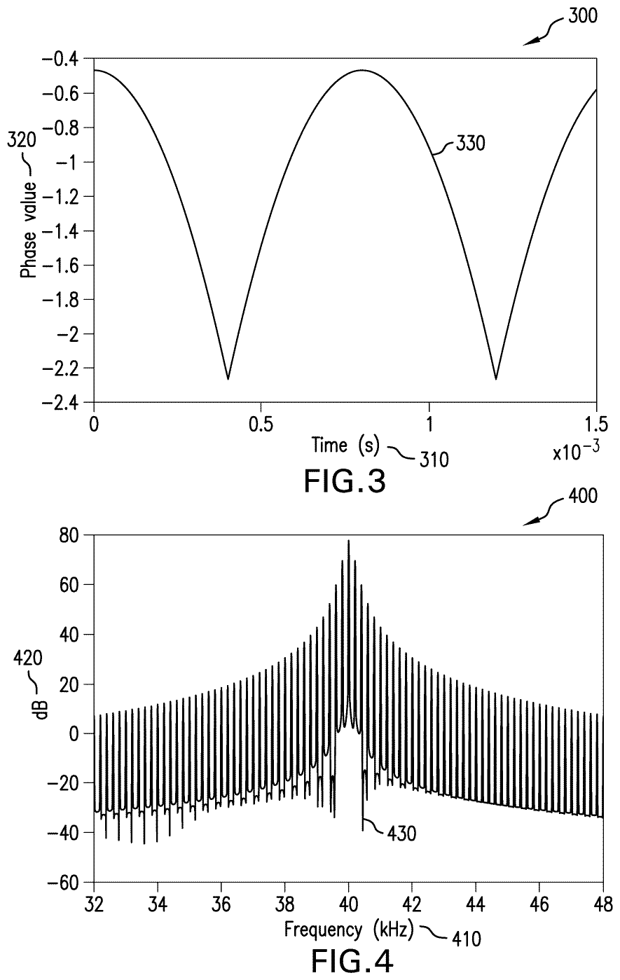

FIG. 3 shows a graph 300 of the resulting phase function for a transducer directly below one end of the line which in this case is 3 cm in length. The x-axis 310 is time in seconds. The y-axis 320 is the phase value. A plot 330 of phase versus time for a fixed-velocity horizontal line at a height of 20 cm and 3 cm in length for an emitter placed directly under starting point operating at 125 Hz.

The phase function value is related to the distance of the focal point to the transducer. On one end of the line (the closest point) the phase function is smooth because the distance versus time is also smooth. If the line were to be extended past this point, the distance to the transducer would start to extend again. It is this minimum distance which causes the smooth inflection point. The far point, however, represents an abrupt stop and reverse of the phase function.

The resulting ‘kink’ in the curve causes many harmonics and noise. This is shown in FIG. 4, which is a graph 400 of a plot 430 showing a frequency power spectrum resulting from the phase function shown in FIG. 3. The x-axis 410 is frequency in kHz. The y-axis 420 is dB.

The goal of the methods presented below is to provide a framework to make arbitrary haptic curves with smooth phase functions to reduce undesired parametric audio. These do not represent all solutions but merely give some specific examples on how it may be done. Solutions may include subdividing an input curve into discrete points, but this is not necessary for all methods. Any solution which provides a continuous solution can also be sampled to produce a discrete solution.

### I. Method 1: Direct Radius Smoothing

The phase function for a given transducer is directly proportional to the distance that transducer is from the focus. Therefore, we can smooth this function directly by choosing a path parameterization which gives a smooth distance versus time from a given transducer.

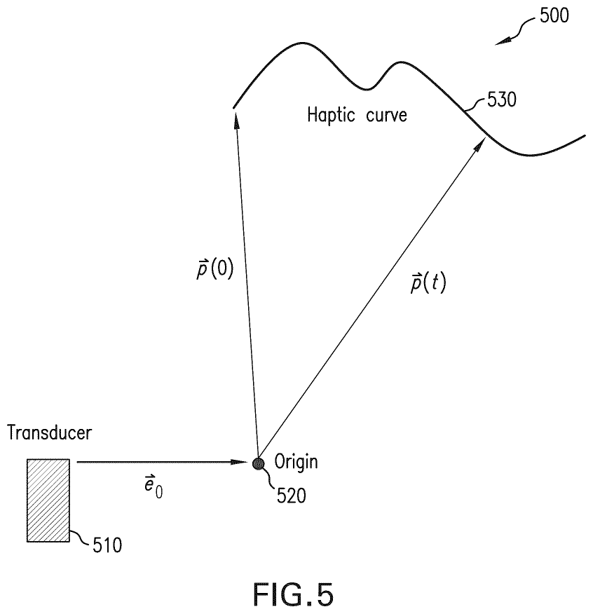

FIG. 5 shows a schematic 500 of geometry for an arbitrary TPS curve and radius smoothing. FIG. 5 includes a transducer 510, an origin point 520 and a haptic curve 530.

Using the geometry presented in FIG. 5, a haptic path is parameterized as the following,

$$\vec{P} ( t ) = {\vec{e}}_{0} + \vec{p} ( t ) = ( {e}_{0 x} + {f}_{x} ( t ) ) \hat{x} + ( {e}_{0 y} + {f}_{y} ( t ) ) \hat{y} + ( {e}_{0 z} + {f}_{z} ( t ) ) \hat{z} .$$

The radius function is then,

$$R ( t ) = \sqrt{{( {e}_{0 x} + {f}_{x} ( t ) )}^{2} + {( {e}_{0 y} + {f}_{y} ( t ) )}^{2} + {( {e}_{0 z} + {f}_{z} ( t ) )}^{2}} .$$

The goal is then to create a mapping function, g(t) which smooths the radius function. Using a single-frequency smoothing function, a mapping function g(t) would be,

$$R ( g ( t ) ) = ( {R}_{f} - {R}_{0} ) ( \text{.5} - \text{.5} cos ( ω t ) ) + {R}_{0} = \sqrt{( {e}_{0 x} + {{f}_{x} ( g ( t ) )}^{2} + ( {e}_{0 y} + {{f}_{y} ( g ( t ) )}^{2} + ( {e}_{0 z} + {{f}_{z} ( g ( t ) )}^{2}}$$

While analytic solutions do not always exist, a simple solver should get close enough to be effective in most cases. This particular radius smoothing function expects R_{f} to be larger than R₀ so an arbitrary curve would need to be divided into sections of monotonically increasing or decreasing sections. For the increasing sections, solve as normal. For the decreasing sections, it needs to be solved from the last point to the first and then read in reversed order.

The new curve would then be,

$$\vec{P} ( t ) = {\vec{e}}_{0} + \vec{p} ( g ( t ) ,$$

using the selected transducer as the center of the coordinate or simply [symbol] (g(t)), from the origin.

Using this mapping function, one transducer (\vec{e}₀) 510 would have a perfect, single-frequency phase function. Other transducers would get increasingly less-perfect as their distances increase from the solved transducer. This method works well if the perfect-transducer for the solver is the farthest one from the haptic interaction.

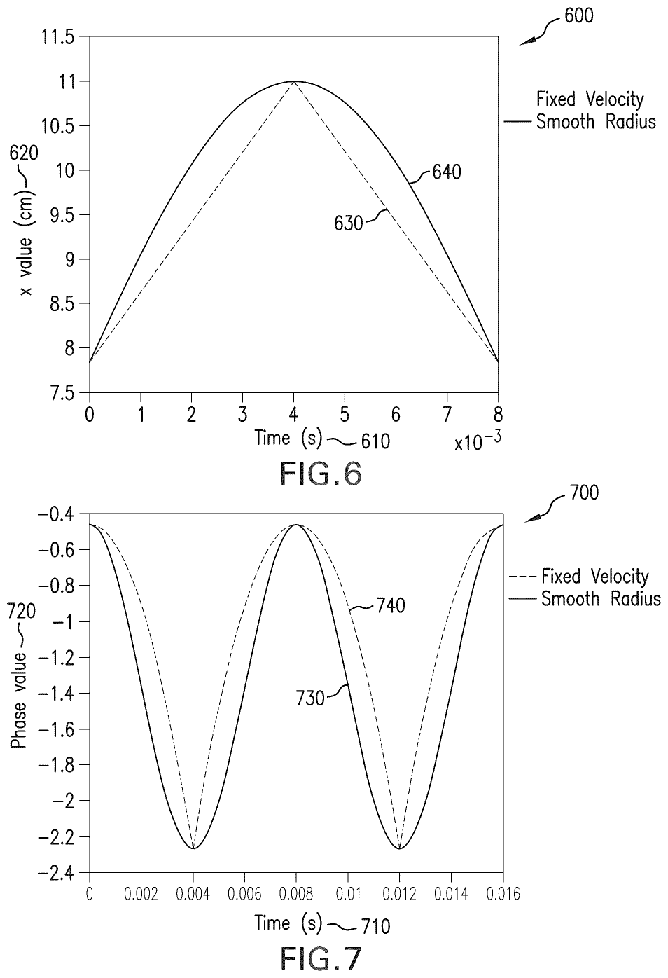

FIG. 6 shows a graph 600 of the results of applying method 1 smoothing for a line extending from 8 cm to 11 cm in the x-axis extending from the center of an array. The x-axis 610 is time in seconds. The y-axis 620 is the x value in cm. The plot shows a fixed velocity 630 and smooth radius 640 lines. Because the fixed velocity line 630 is already at a spatiotemporal minimum at the start, it is not affected. The far end of the fixed velocity line 630 receives most of the adjustment.

Shown in FIG. 7 is a graph 700 of a phase function for a transducer directly below one end of the line given in FIG. 6. The x-axis 710 is time in seconds. The y-axis 720 is phase value. The plot shows a fixed velocity 740 and smooth radius 730 lines.

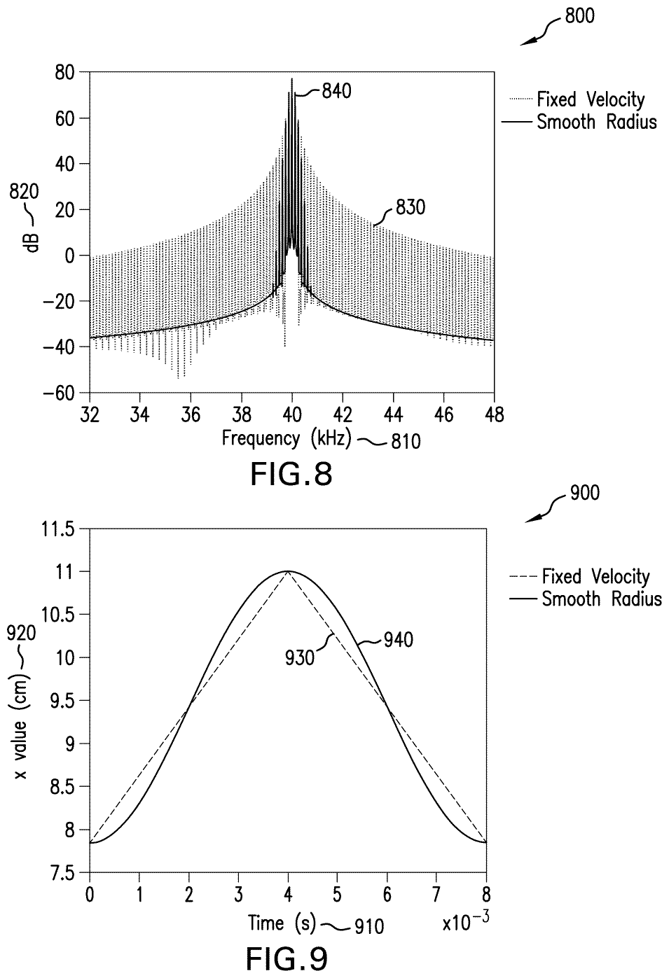

Shown in FIG. 8 is a graph 700 of a frequency power spectrum for the two curves shown in FIG. 6. The x-axis 810 is frequency in kHz. The y-axis 820 is dB. The plot shows a fixed velocity 830 and smooth radius 840 lines.

With far fewer sidebands, the smoothed curve will produce less parametric audio.

While best implemented with foreknowledge of the desired path, this method can be implemented in real-time with a sample buffer where points are redistributed in blocks, dividing the curve into increasing and decreasing distance. A sufficiently large buffer would be needed so as to always include enough points to divide the space into distinct sections. This would be a function of the update rate and the size of the possible interaction regions.

### II. Method 2: Temporally Smooth Points Distributions

An approximation of the previous method may be achieved by manipulating traversal rate on the path so that it has minimum velocity at sharp points which might cause noise. If [symbol] (t) represents a fixed-velocity parametrized TPS curve which starts and stops at a hard location (such as a line), a minimum-velocity curve would be,

$${\vec{P}}_{smooth} ( t ) = \vec{P} ( \text{.5} - \text{.5} cos ( π \frac{t}{{t}_{f}} ) )$$

where t_{f} is the time representing the end of the curve. To return to the start of the curve the phase functions can be run in reverse. This results in a low-spread power spectrum.

FIG. 9 is a graph 900 showing the application of this method smoothing to a line extending from 8 cm to 11 cm in the x-axis extending from the center of an array. The x-axis 910 is time in seconds. The y-axis 920 is x-value in cm. The plot shows a fixed velocity 930 and temporally radius 640 lines.

This method is unaware that the start of the curve is already a spatiotemporal minimum and therefore smooths both ends. While not perfect for the presented transducer, the net result over all of the transducers in the array can be very similar in total to the other methods presented.

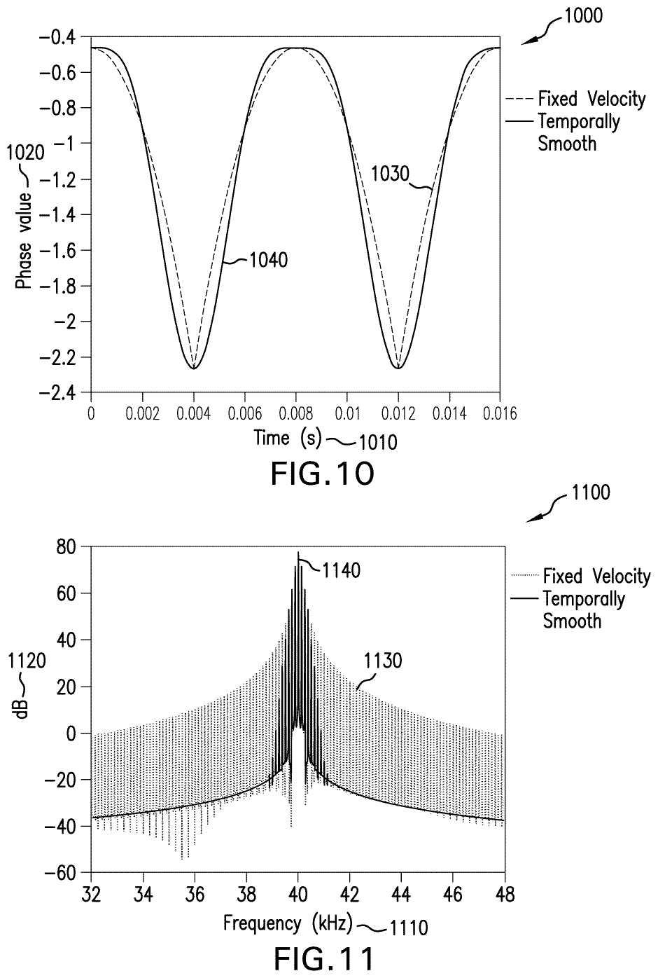

Shown in FIG. 10 is a graph 1000 of a phase function for a transducer directly below one end of the line given in FIG. 6. The x-axis 1010 is time in seconds. The y-axis 1020 is phase value. The plot shows a fixed velocity 1030 and temporally smooth 730 lines.

Shown in FIG. 11 is a graph 1100 of a frequency power spectrum for the two curves shown in FIG. 6. The x-axis 1110 is frequency in kHz. The y-axis 1120 is dB. The plot shows a fixed velocity 1130 and smooth radius 1140 lines.

This can be implemented in real-time with a sample buffer or with sub-sampling. A sample buffer would have to look ahead for sharp transitions and redistribute to first accelerate to get ahead in space and then decelerate into those points. Sub-sampling would be done by assuming each point is itself a “sharp” transition and distributions would follow a smooth function (like above) in between on a direct-line path. This should be especially effective if the accepted point rate is at 400 Hz or less with an update rate of 40 kHz or higher.

### III. Method 3: Spatial Filtering

The radius function for an arbitrary haptic path is given by:

$$R ( t ) = \sqrt{{( {e}_{0 x} + {f}_{x} ( t ) )}^{2} + {( {e}_{0 y} + {f}_{y} ( t ) )}^{2} + {( {e}_{0 z} + {f}_{z} ( t ) )}^{2}} .$$

From this equation, it is clear that spatial functions (fₓ(t), etc) with high-frequency content will directly translate to high-frequency content in R(t). If we filter the spatial functions directly, R(t) and therefore the phase function for the curve, will have a minimum of high-frequency content.

This can be accomplished with any number of standard frequency filtering approaches, both pre-processed and real-time. Processing continuous curves can be done with analogue filter implementations. Curves divided into a series of points can be filtered using traditional digital methods such as infinite impulse response (IIR) and finite impulse response (FIR) filters. Each dimension at a time must be filtered individually.

Frequency filtering approaches fall into two categories: ones involving feedback/feedforward called infinite impulse response (IIR) and ones without feedback called finite impulse response (FIR). IIR filtering requires less buffering and computation cost but often introduces phase delay. FIR filtering can be phase-perfect but requires a buffer equal to the size of the coefficients which can get large for low-frequency filtering.

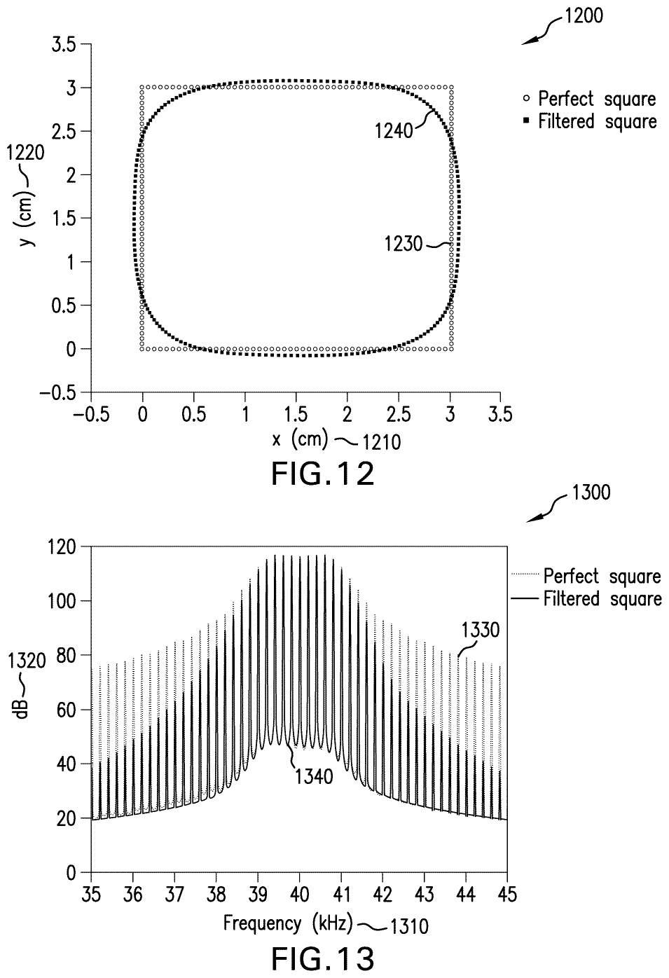

FIG. 12 shows a graph 1200 of 3 cm 200-point square curve 1230 filtered by a 2^{nd} order Butterworth (IIR) filter at sampled at 400 Hz (200 Hz). The x-axis 1210 is x in cm. The y-axis 1220 is y in cm. Shown is one loop of the steady-state response. The resulting curve 1240, while not identical to the input curve, is largely indistinguishable using 40 kHz ultrasound due to focusing resolution.

FIG. 13 shows a graph 1300 of the frequency power spectrum for the two curves shown in FIG. 12. The x-axis 1310 is frequency in kHz. The y-axis 1320 is in dB. The plot shows a perfect square 1330 and a filtered square 1340. This is the absolute sum of the output of 256 individual transducers located at 1 cm pitch in a 16×16 array. In this case, the data presented represents the sum of all the transducers placed at 1 cm pitch in a 16×16 square array.

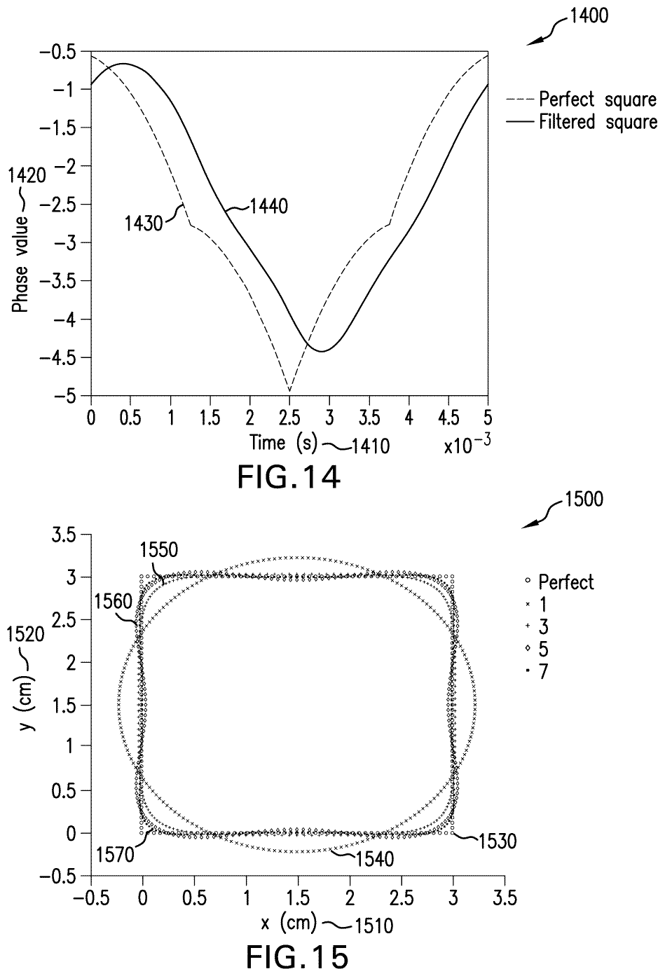

FIG. 14 shows a graph 1400 of the phase function for a transducer located near the origin in FIG. 12. The x-axis 1410 is time in seconds. The y-axis 1420 is phase value in dB. The plot shows a perfect square 1430 and a filtered square 1440. The smoothing of the phase function for a transducer located under one corner of the square is shown in FIG. 14.

Filtering can be adjusted to achieve the desired balance between path reproduction accuracy and audio reduction.

### IV. Method 4: Spatial Approximations (Fourier, Splines, Polynomials, Etc.)

Any input path or series of points representing a path can be approximated with smooth path using curve fitting techniques.

For example, a haptic path is often repeated several times in order to create a haptic sensation. If a complete loop is buffered in advance, this nicely encapsulates a repetitive sequence and can be expressed as a Fourier series. Being directly related to the frequency domain, increasing orders of approximation directly relates to the trade-off between accuracy and unwanted audio. The Fourier series approximation is given by,

$$f ( x ) = \frac{1}{2} {a}_{0} + {\sum }_{n = 1}^{∞} {a}_{n} cos ( nt ) + {\sum }_{n = 1}^{∞} {b}_{n} sin ( nt ) ,$$

$$where ,$$

$${a}_{0} = \frac{1}{π} {\int }_{- π}^{π} f ( t ) dt ,$$

$${a}_{n} = \frac{1}{π} {\int }_{- π}^{π} f ( t ) cos ( nt ) dt ,$$

$${b}_{n} = \frac{1}{π} {\int }_{- π}^{π} f ( t ) sin ( nt ) dt ,$$

where the integrals are taken over one period. Each dimension would need to be approximated separately.

FIG. 15 is a graph 1500 showing an example of a 3 cm square with increasing orders of Fourier series expansion. The x-axis 1510 is x in cm. The y-axis 1520 is y in cm. The plots 1530, 1540, 1550, 1560, 1570 respectfully represent the maximum order included in each expansion of perfect, 1, 3, 5 and 7.

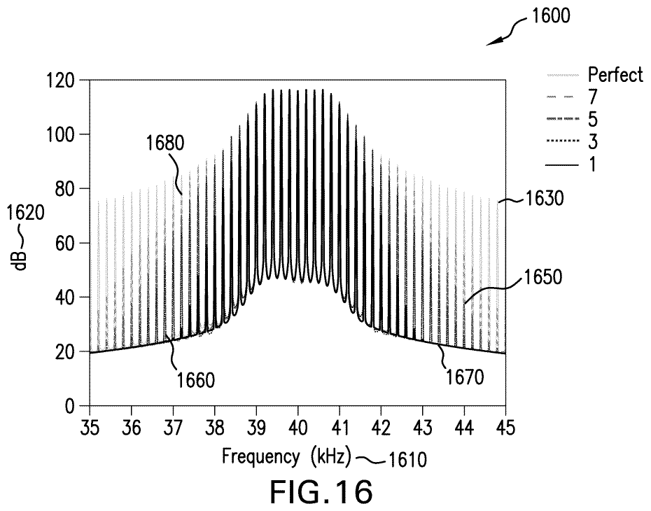

FIG. 16 shows a graph 1600 of the frequency power spectrum for the curves shown in FIG. 15. This is the absolute sum of the output of 256 individual transducers located at 1 cm pitch in a 16×16 array. The x-axis 1610 is frequency in kHz. The y-axis 1620 is dB. The resulting power spectrums 1630, 1640, 1650, 1660, 1670 show how increasing the order of the approximation (respectively perfect, 7, 5, 3, 1) yields more sidebands and more audio as a result of better path reproduction. The approximation would need to be updated every time the haptic loop is updated. Transitioning between them would need another method discussed in this document to avoid high-frequency jumps.

Polynomial fits are another class of smooth functions which can easily be fit to a set of input points. Critical points can be chosen in advance or in a buffered or sub-sampled signal and a fitting routine such as least-squares can be used to fit a low-order polynomial. Selecting critical points with sudden stops or high curvature will likely be the most effective. The higher-order used, the more accurate the curve will be to the input points, but the higher curvature will allow for higher frequency content. Essentially non-oscillatory (ENO) polynomials may also be used to counter this through the weighted selection of high-order polynomial interpolations which are representative yet minimize unwanted high-frequency content. If desired, the number of critical points could relate to the order of the polynomial fit in order to include those points exactly (a determinate system). If implemented real-time, the fit would need to update smoothly as new critical points are determined.

Splines offer yet another curve approximation system which can emphasize smoothness and low curvature. As with other methods, the input could be critical points from a sub-sampled system or chosen algorithmically from an input buffer.

### V. Additional Disclosure

As far as is known, no attempt has ever been made to adjust curve parameterization (point spacing/location) in order to improve unintended audio. The idea here is recognizing the direct relationship between spatial spectral content and parametric audio.

These techniques are much easier to implement at a software level versus direct filtering at the firmware level. These techniques are easier to tune to adjust accuracy versus audio.

Additional disclosure is as follows:
1. A method comprising:
creating haptic feedback using ultrasound comprising the steps of:
producing an acoustic field from a transducer array having known relative positions and orientations;
defining a focus point having a known spatial relationship relative to the transducer array
defining a path having a known spatial relationship relative to the transducer array in which the focus point will translate;
moving the focus point near the path so as to produce little audible sound.
2. The method as in paragraph 1, further comprising:
moving the focus point near the path in a method selected to produce a smooth phase function for a transducer.
3. The method as in paragraph 1 wherein the focus point moves near the path to produce a phase function with reduced high-frequency content for a transducer.
4. The method as in paragraph 1, wherein the focus point moves near the path so as to produce a smooth radius versus time from a transducer.
5. The method as in paragraph 1, wherein the focus point moves so that it spends more time near locations in the curve with tight curvature or end points.
6. The method as in paragraph 1 wherein the path is filtered to reduce high-frequency spatial content.
7. The method as in paragraph 1 wherein the path is approximated by approximation functions using a second path with reduced high-frequency content.
8. The method as in paragraph, 1 wherein the path is subdivided into multiple focal points.
9. The method as in paragraph 8, wherein the multiple focal points are distributed along the path to produce a smooth phase function for a transducer.
10. The method as in paragraph 8, wherein the multiple focal points are distributed along the path to produce a phase function with reduced high-frequency content for a transducer.
11. The method as in paragraph 8, wherein the multiple focal points are distributed along the path so as to produce a smooth radius versus time from a transducer.
12. The method as in paragraph 8, wherein the multiple focal points are distributed along the path such that the multiple focal points are more closely distributed at locations with tight curvature or end points.
13. The method as in paragraph 8, wherein spatial locations of the multiple focal points are filtered to remove high-frequency content.
14. The method as in paragraph 8, wherein the path is approximated by approximation functions using functions with reduced high-frequency content.

### [Docket 81]

### (2) Dynamic Transducer Activation Based on User Location Information for Haptic Feedback

### I. Feed-Forward Input Generation for a Desired Output Via Linear Algebra

The impulse response of a system can be used to predict its output for a given drive by use of convolution,

$${V}_{out} ( t ) = {V}_{in} ( t ) * h ( t ) ,$$

where Vₒᵤₜ(t) is the output of the system, Vᵢₙ(t) is the driving signal, h(t) is the system's impulse response, and * is the convolution operator. One way to organize a system is to divide the past of the system into segments each with fixed time interval T. Past drive signals are grouped into equal-time segments and designated by the number of periods in the past they represent. If these signals are Dₙ where n represents the number of periods in the past, this results in:

$${V}_{0} ( t ) = {D}_{0} ( t ) * h ( t ) + {D}_{1} ( t ) * h ( t - T ) + {D}_{2} ( t ) * h ( t - 2 T ) + ⋯ , \qquad ( 1 )$$

where V₀ and D₀ represent the output and drive of next cycle to be produced and all other terms encapsulate the history of the system. The time offsets may be foregone by writing this as an index, hₙ=h(t−nT). The notation may be simplified by denoting vectors D=└D₁, . . . , Dₙ ┘ and h=└h₁, . . . , hₙ┘, where each entry in the vector is the time-series data for the drive and impulse response respectively. The convolution operator would then first convolve then add as a vector product. Equation 1 can then be written as,

$${V}_{0} = {D}_{0} * {h}_{0} + D * h ,$$

and the inverse problem which we are trying to solve is,

$${D}_{0} = ( {V}_{0} ( D * h ) ) {*}^{- 1} {h}_{0} ,$$

where *⁻¹ is the deconvolution operator.

This solution may be expanded to an array of coupled systems by measuring the impulse response of one element when another is driven. Take, for example, two elements A and B. The impulse response of A when B is driven is defined as h_{BA} and the opposite case of response of B when A is driven as h_{AB}. The traditional impulse response in this notation would be h_{AA} and h_{BB} respectively. The above analysis reduces to a system of two equations,

$${V}_{A 0} = {D}_{A 0} * {h}_{AA 0} + {D}_{A} * {h}_{AA} + {D}_{B 0} * {h}_{BA 0} + {D}_{B} * {h}_{BA} ,$$

$${V}_{B 0} = {D}_{B 0} * {h}_{BB 0} + {D}_{B} * {h}_{BB} + {D}_{A 0} * {h}_{AB 0} + {D}_{A} * {h}_{AB} ,$$

where the 0 subscripts represent the next cycle for the various parameters, Dₐ and D_{B} are the vectors of time-series driving data analogous to D above, and V_{A0} and V_{B0} are the output of each element. When V_{A0} and V_{B0} are specified this reduces to an indeterminate system in which a solution can be approximated. This technique can be expanded to an arbitrarily sized array of elements. This is the most general form of the invention. This formula calculates the necessary drive (D₀) for a desired output (V₀) given the history of the drive contained in D*h. Presented below are methods to simplify the deconvolution process under certain conditions.

While convolution calculations are straightforward, the inverse problem is often difficult. Deconvolution algorithms can be computationally challenging and can yield oscillatory or unstable behavior. A major simplification can be made when working with high-Q resonant systems by using the convolution theorem. This states that the Fourier transform of two convolved signals is the multiplication of their individual Fourier transforms. In a resonant system, the Fourier transform the impulse response is dominated by the component at the resonant frequency. If the driving signal are kept largely monochromatic, the system may be reduced largely to algebra. In the above notation this takes the form,

$$ℱ ( {V}_{0} ) = ℱ ( {D}_{0} * {h}_{0} + {D}_{1} * {h}_{1} + {D}_{2} * {h}_{2} + ⋯ ) \approx A ( {V}_{0} ) = A ( {D}_{0} ) \cdot A ( {h}_{0} ) + A ( {D}_{1} ) \cdot A ( {h}_{1} ) + A ( {D}_{2} ) \cdot A ( {h}_{2} ) + ⋯ , \qquad ( 2 )$$

where [symbol] denotes the Fourier transform, and A is an operator which returns the complex Fourier component at the resonant frequency of the element. By specifying the desired output in terms of the resonant frequency complex Fourier component (A(V₀)), each term on the right are simply complex values, and the system is now algebraic. The single-element control function in this notation reduces to:

$${D}_{0} = ( {V}_{0} - ( D \cdot h ) ) / {h}_{0} . ) \qquad ( 3 )$$

In this case both the output (V₀), drive (D₀), and first-period impulse response (h₀) would be complex numbers representing the Fourier component at the resonant frequency. D and h are vectors containing the time shifted impulse response and drive Fourier components respectively. The number of historical data points to include in any one timestep is dependent on the desired accuracy of the drive as well as the computational power available. The complex output is relatively easy to realize in practice and will be covered below.

An array of coupled elements can be similarly simplified. Given an array with m elements the equation 3 can be written as,

$$\begin{matrix}V = ( \begin{matrix}{V}_{1} \\ ⋮ \\ {V}_{m}\end{matrix} ) {h}_{n} = ( \begin{matrix}{h}_{11 n} & {h}_{21 n} & … & {h}_{m 1 n} \\ {h}_{21 n} & {h}_{22 n} & ⋱ & ⋮ \\ ⋮ & ⋱ & ⋱ & ⋮ \\ {h}_{m 1 n} & … & … & {h}_{mmn}\end{matrix} ) , {D}_{n} = ( \begin{matrix}{D}_{1 n} \\ ⋮ \\ {D}_{mn}\end{matrix} ) , \\ {D}_{0} = {h}_{0}^{- 1} ( V - ( {h}_{1} {h}_{2} … {h}_{n} ) ( \begin{matrix}{D}_{1} \\ {D}_{2} \\ ⋮ \\ {D}_{n}\end{matrix} ) ) ,\end{matrix} \qquad ( 4 )$$

where n refers to the given period delay offset, the numbered indexes in the impulse response are the impulse on the second number with the first number driven (as above), and

$${h}_{0}^{- 1}$$

is the inverse of the first-cycle impulse response matrix. The output of this, like equation 2, is an array of complex driving coefficients for the m transducers given the desired m outputs in V.

Another simplification of the above method can be accomplished through a recursive definition of the impulse response function. In many systems, the impulse response function can be approximate by purely exponential decay. In this case, the total contribution from the previous activations can be approximated by,

$${\sum }_{n = 1}^{∞} {D}_{n} \cdot {h}_{n} \approx {D}_{1} \cdot {h}_{1} + α {\sum }_{n = 2}^{∞} {D}_{n} \cdot {h}_{n} ,$$

where α is an experimentally derived constant. Each cycle the previous contribution is multiplied by α and summed with the new cycle. In this way, only one multiplication is necessary each cycle to calculate the complete historical contribution. This simplification works very well for systems well described by a damped harmonic oscillator. This can be applied on an element-by-element basis for an array system but tends to only work well if the cross-coupling is minimal as the first-order nature of this recursive filter does not pass ringing. A hybrid recursive filter can be made by including a fixed number of cycles using the previous explicit method and then lumping the remainder into a recursive term. If the bulk of the ringing behavior can be captured in the fixed cycles which are explicitly calculated, the remainder should be well described by a recursive approach.

Resonant systems can display non-linear behavior near the resonant frequency. This can manifest as a nonlinearity in the amplitude response. As a result, the impulse response function changes as a function of current drive level. This can cause the estimation of the previous contributions (Dh) to be inaccurate at high drive levels. To compensate for this, the impulse response matrix must become a function of drive level. For each element the impulse response can be measured for a given amplitude, h(A). Using this notation, the driving activation coefficients can be calculated using,

$${D}_{0} = {h}_{0}^{- 1} ( V - {\sum }_{n = 1}^{{n}_{max}} {h}_{n} ( {A}_{n} ) \cdot {D}_{n} ) \qquad ( 5 )$$

### Where

$${h}_{0}^{- 1}$$

is the small-amplitude impulse response. For the next period the amplitude(s) used to modify h can be estimated using the Do just derived,

$${A}_{0} = {h}_{0} \cdot {D}_{0} + {\sum }_{n = 1}^{{n}_{max}} {h}_{n} ( {A}_{n} ) \cdot {D}_{n} , \qquad ( 6 )$$

where Aₙ are calculated from previous time steps (already calculated in 2 and can be reused). In this notation Dₙ and Aₙ are the drive and amplitude at n periods in the past and hₙ is the time-shifted impulse response for that amplitude. In our notation, for the next timestep, this would be incremented to A₁ and used within the historical term in equation 5 above.

The methods presented above rely on an accurate impulse response. In a real system, this can change under various environmental conditions including temperature, altitude, age, and many others. Accuracy of the methods depend on tracking the most important factors and adjusting the impulse responses accordingly. This can be implemented using a large store of recorded impulse responses which are then accessed based on external sensors or clocks. Alternatively, a different resonant driving frequency can be used which could restore accuracy to the impulse response as most decay and cross talk mechanisms will remain largely similar even if the resonant frequency of the system changes. In another arrangement, a mathematical model of the change in impulse response can be implemented in the system to change the stored impulse response over time and function. In yet another arrangement, the device can be setup to measure the impulse response at certain times such as start-up or during periods of minimal output to re-adjust the internal tables. This could be accomplished electrically via an impedance sweep or with some other electrical measuring method. Alternatively, feedback from an external measurement device (such as a microphone for an ultrasonic transducer system) could be used to update tables.

The feed-forward control scheme can introduce some high-frequency components to the drive which could be detrimental in certain applications (high-power airborne ultrasound for instance). In this case there are a number of possible solutions to limit the high-frequency components while still retaining the precise control of feed-forward. One simple method is to simply apply IIR low-pass filters to the output drive coefficients of equation 1 (one for each of the real and imaginary components). For each cycle, the previous cycle's output is the output of the filter, then a new drive term is calculated with equation 1, and that is filtered, and so on. Another option is a simple comparison of the change of D from one cycle to the next and limit this to a certain magnitude (point by point), this limited D is the input to the history term in the next cycle. This is effectively a low-order low-pass filter.

The filter, or magnitude limiter, can adapt to the input, by analyzing the bandwidth of the input and applying a filter which starts to attenuate based on that value. For the simple case of a magnitude-change filter, a running max change from the previous n input samples could be stored and that could be used as the limiting change. In that way if the input is requesting high-frequency changes, high-frequency changes are passed, but if the input is slow and smooth, the output coefficients are also limited in their rate of change. In another implementation, the input signal could be analyzed for frequency content (say with a series of band filters) and an adjustable IIR filter applied to each driving term based upon the input frequency analysis. The exact relationship between the content of the input and filtered output can be adjusted to optimize accuracy (by passing all frequencies) versus noise (heavily filtering).

Examples shown in the figures are generated using a 2-level PWM interpretation of the coefficient output equation 1. This is done simply by matching the Fourier component of PWM to the desired output by adjusting the phase and width of the pulse. When an amplitude requested exceeds what is possible by the drive, phase can still be preserved by amplitude is kept at maximum duty cycle (50%). This clipping of amplitude does not impede the method and is implemented in the simulations above. Despite this being the only type of simulation shown, the invention presented here is not limited to a 2-level PWM drive. Any drive system will work from PWM to analogue. The only requirement is that the drive for each resonant-frequency-period have a Fourier component at that frequency which matches in the output from equation 1. The cleaner the drive is from a frequency perspective, the better the system will perform. This can be achieved by switching many times per cycle, many different voltage levels available, or a full high-bandwidth analogue drive.

Feedback from an external pickup could also be incorporated.

Feed-forward drive allows for the precise control of resonant systems.

Possible uses include:

1. Controlling arrays of resonant ultrasonic transducers for parametric audio. By more accurately controlling each element, the quality of reproduction will increase as well as being able to more carefully steer and control the ultrasound field.

2. Controlling an array of resonant ultrasonic transducers for haptic feedback. Better control of the amplitude and phase will allow for better focus control (smaller focus, cleaner modulation) and less unwanted audio

3. Controlling one or an array of ultrasonic transducers for ranging. Distance estimates involve encoding a ‘key’ into the ultrasound output on top of either amplitude or phase. In the simplest application, this would simply be a ‘pulse’ which turns on and off. In other applications where the transducer is continually producing output, the key could be a deliberate phase shift. The sharper the key is in time, the more accurate the range calculation is on reception. The method presented allows for sharper transitions than what is capable in standard control.

4. PWM control of motors with resonant behavior.

5. Control of resonant loudspeakers.

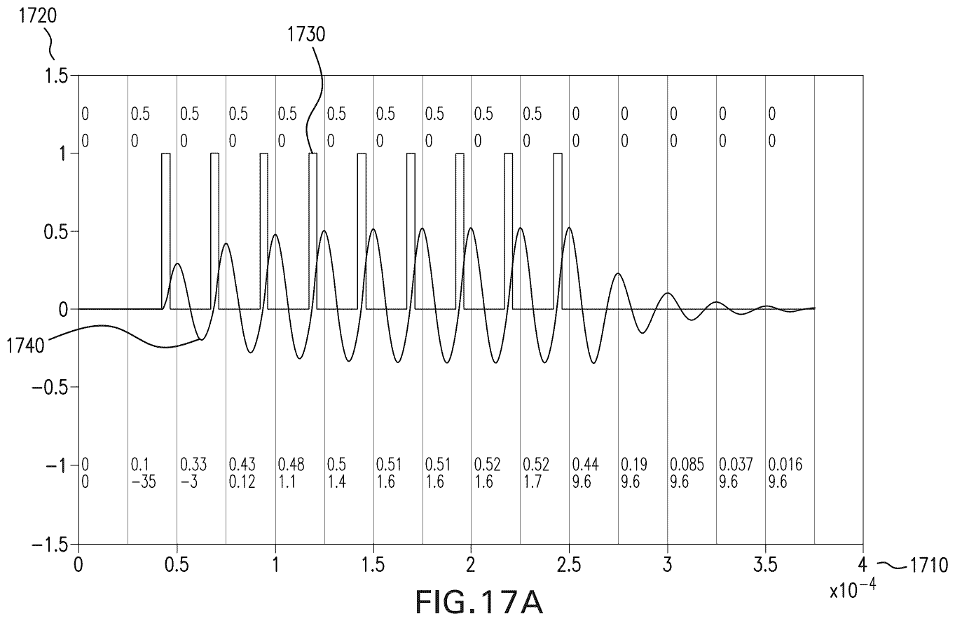

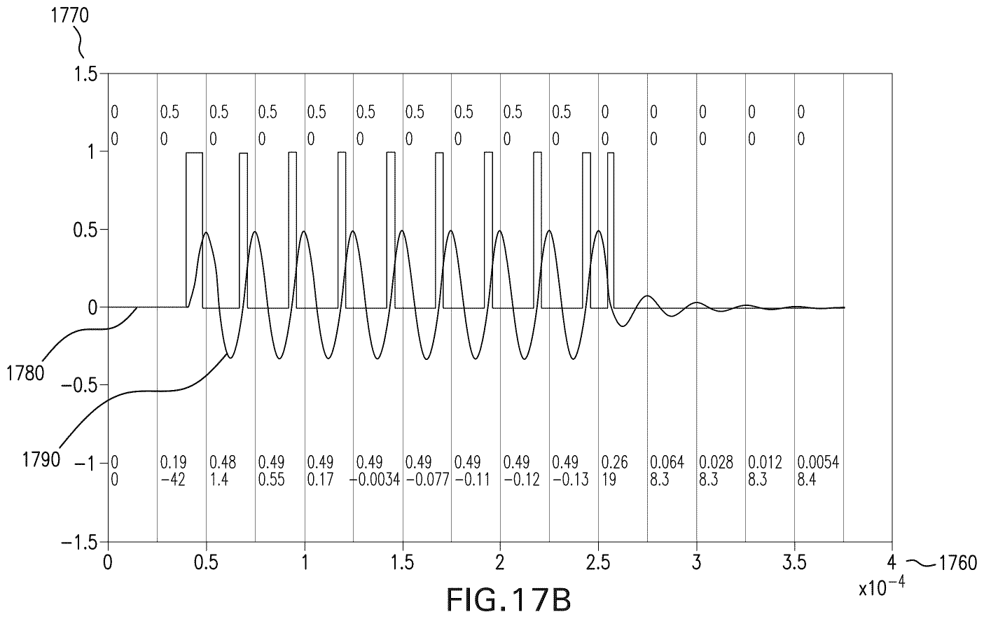

FIGS. 17A and 17B show a pair of graphs 1700, 1750 that are a simple model demonstration of a basic drive versus feed-forward control (this invention). The x-axis 1710, 1760 are unitless scale values. The y-axes 1720, 1770 are unitless scale values. The curved plot lines 1740, 1790 represent the motion of the system and the straight plot lines 1730, 1780 are the drive. Vertical lines denote resonant periods of the model system. The system has a rise-time of about 5 cycles. The numbers above the curves are the input amplitude and phase and the lower numbers are the resulting output amplitude and phase. In FIG. 17A, the drive is only related to the input and the straight plot lines 1730 are the same every cycle. In FIG. 17B, the drive uses information about the history of the transducer drive and drives in such a way to both drive harder (at the start) and drive in such a say to damp the motion (at the end). This results in output closer to the input at all points in the control period.

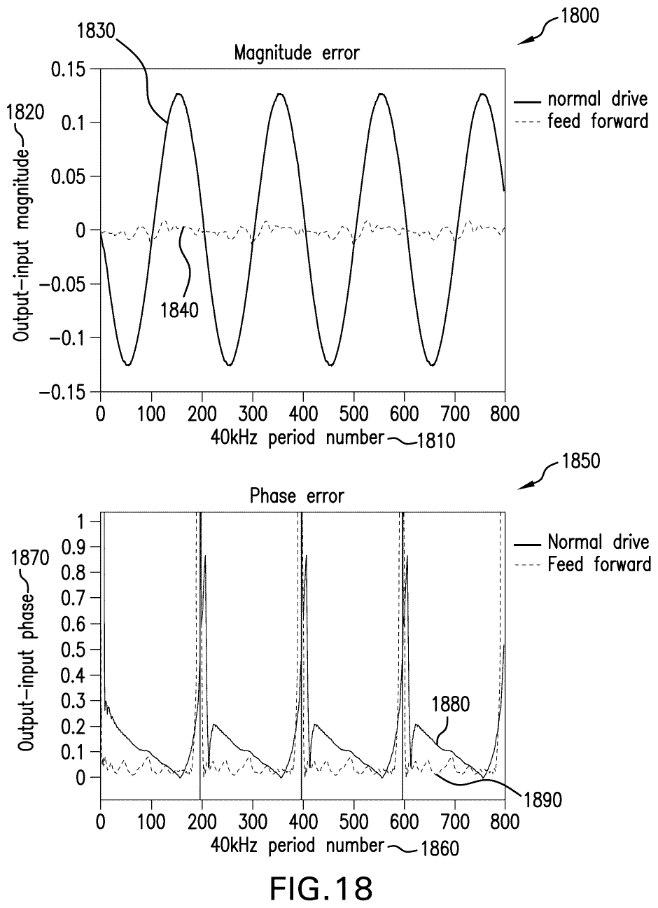

FIG. 18 show a pair of graphs 1800, 1850 showing amplitude and phase accuracy of amplitude-modulated input using regular and feed-forward drive applied to a real-world 40 kHz transducer model. The x-axes 1810, 1860 are the 40 kHz period number. The y-axis 1820 of the first graph 1800 is output-input magnitude. The y-axis 1870 of the second graph 1850 is output-input phase. The plot shows normal 1830, 1880 and feed forward 1840, 1890 drive. The feed-forward system in all the simulations presented here uses 60 terms in the impulse response. Amplitude modulation desired is 200 Hz and full modulation amplitude. Input coefficients are converted to a PWM signal with 100 steps per period to simulate real-world digital drive. The first graph 1800 shows the difference of the output to input over 800 periods. The second graph 1850 shows the difference in phase between the output to input. The feed-forward control 1890 is able to hold the system to better than 2% amplitude accuracy and less than 0.1 radians except near zeros of the amplitude. By comparison, the traditional drive 1880 has more than 10% amplitude error and drifts up to 0.3 radians off target even at non-zero amplitudes.

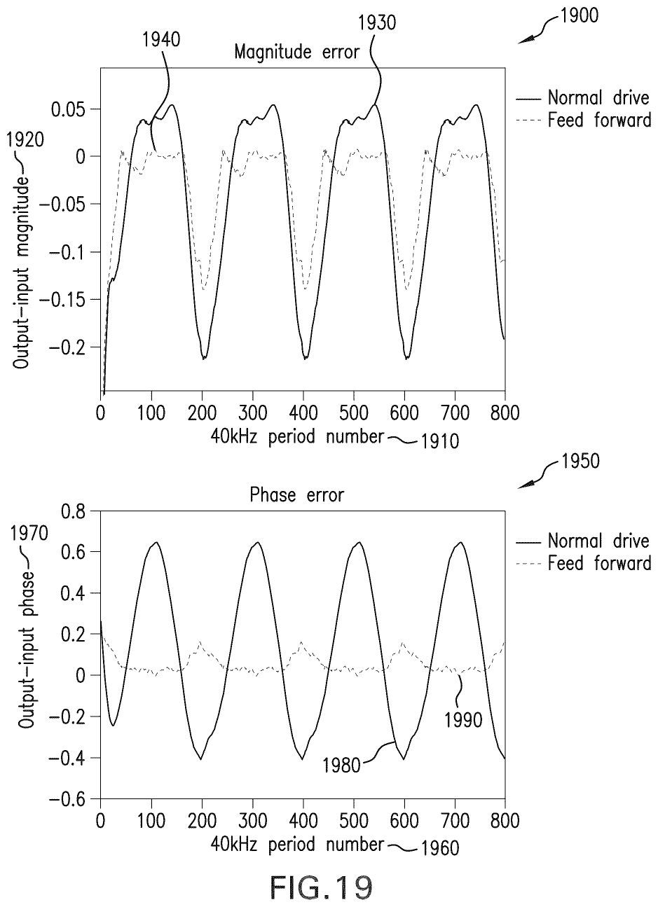

FIG. 19 shows graphs 1900, 1950 of amplitude and phase accuracy of phase-modulated input using regular and feed-forward drive applied to a real-world 40 kHz transducer model. The x-axes 1910, 1960 are the 40 kHz period number. The y-axis 1920 of the first graph 1900 is output-input magnitude. The y-axis 1970 of the second graph 1950 is output-input phase. The plot shows normal 1930, 1980 and feed forward 1940, 1990 drive. The input drive is 90% amplitude and 0.7*pi radians amplitude at 200 Hz. In this case, the transducer is physically not capable of following the requested phase shift as neither system is able to fully match both the amplitude and phase of the requested input. Comparing the two, it is clear that when the request is physically possible (near periods 100, 300, 500, 700) the feed-forward system is able to hold both the phase and amplitude with only a few percent error. When the system does deviate and the errors are significant, the feed-forward system is able to recover faster and even when amplitude dips, is able to keep phase closer to request compared to a traditional drive system.

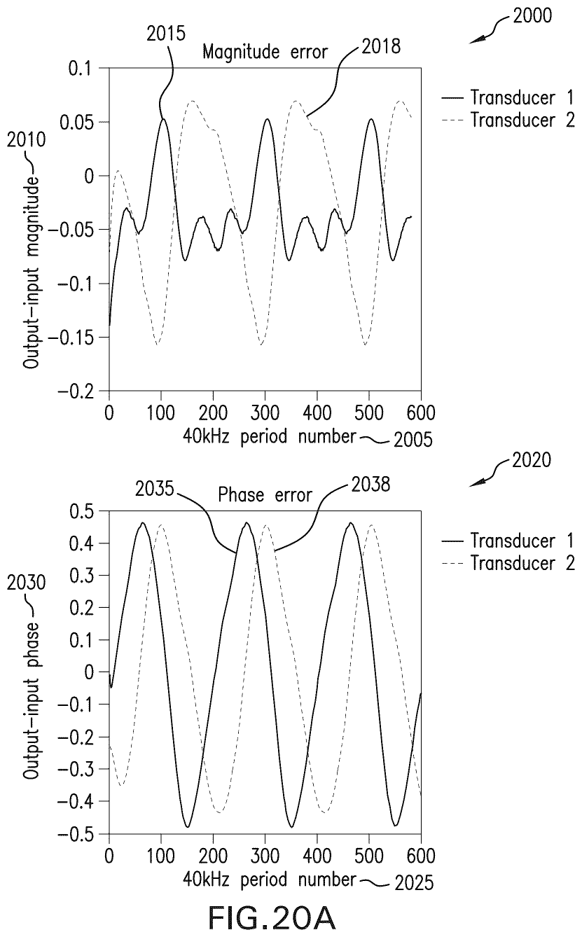

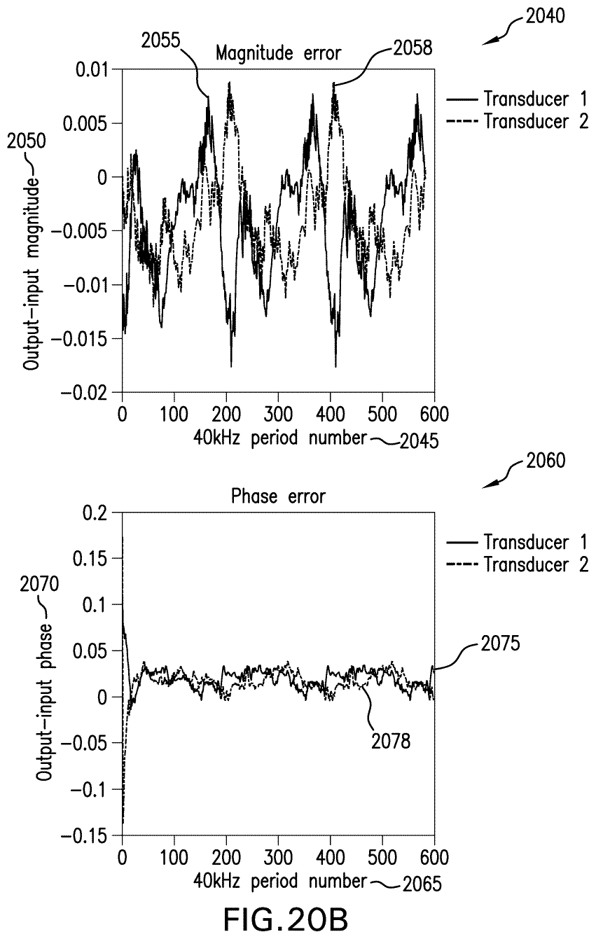

FIG. 20A are graphs 2000, 2020 that use regular drive FIG. 20B are graphs 2040, 2060 that use feed-forward drive. The x-axes 2005, 2025, 2045, 2065 are the 40 kHz period number. The y-axes 2010, 2050 for the magnitude error graphs 2000, 2040 are output-input magnitude. The y-axes 2030, 2070 for the phase error graphs 2020, 2060 are output-input phase. The plots show results for transducer 1 2015, 2035, 2055, 2075 and for transducer 2 2018, 2038, 2058, 2078.

These graphs are examples of cross-talk performance showing amplitude and phase accuracy of two strongly-coupled phase-modulated transducers with transducer 2 at 90 degrees out of phase with transducer 1. The mathematical model uses the same real-world 40 kHz transducer model as the previous figures with an added coupling losses spring. Input coefficients are converted to a PWM signal with 100 steps per period to emulate real-world digital drive. The input drive is 80% amplitude with 0.5*pi radians of modulation at 200 Hz, with transducer 2 at 90 degrees out of phase with transducer 1. The graphs 2000, 2020 show the large errors introduced by coupling with the amplitude dropping by as much as 15%. The graphs 2040, 2060 show the control possible with feed-forward coupled control, with amplitude and phase accuracy on the order of 2%.

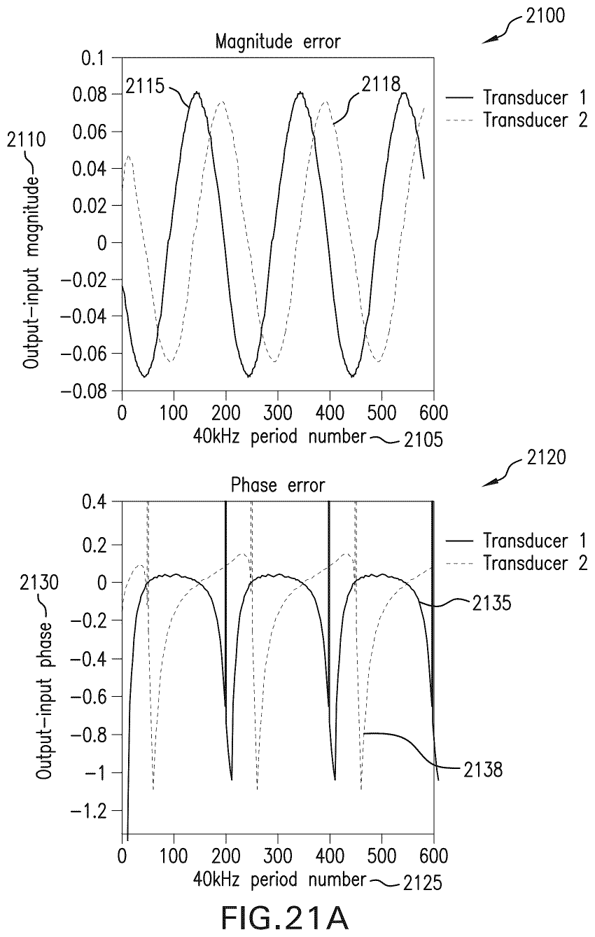

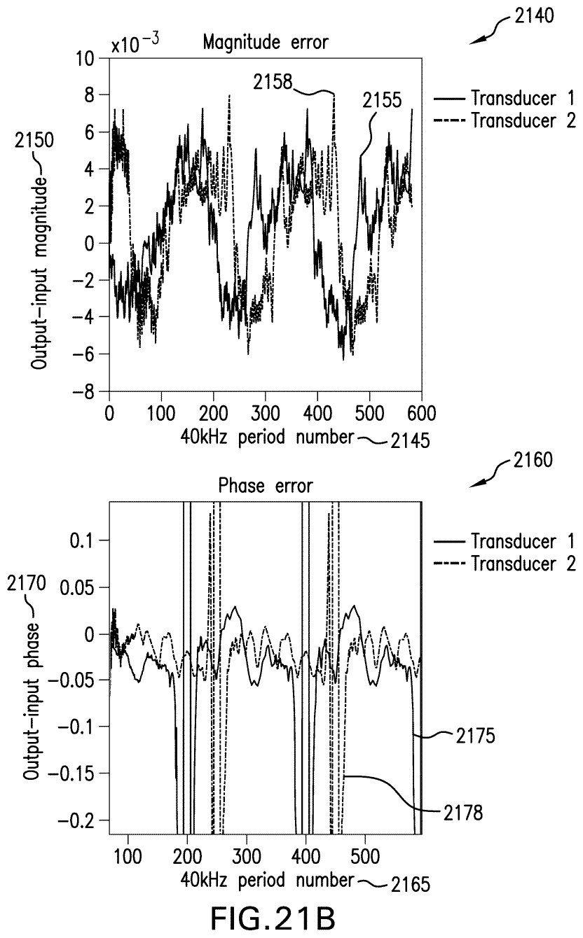

FIG. 21A are graphs 2100, 2120 that use regular drive FIG. 20B are graphs 2140, 2160 that use feed-forward drive. The x-axes 2105, 2125, 2145, 2165 are the 40 kHz period number. The y-axes 2110, 2150 for the magnitude error graphs 2100, 2140 are output-input magnitude. The y-axes 2130, 2170 for the phase error graphs 2120, 2160 are output-input phase. The plots show results for transducer 1 2115, 2135, 2155, 2175 and for transducer 2 2118, 2138, 2158, 2178.

The mathematical model uses the same real-world 40 kHz transducer model as the previous figures with an added coupling losses spring. Input coefficients are converted to a PWM signal with 100 steps per period to simulate real-world digital drive. The input drive is 50% amplitude depth at 200 Hz, with transducer 2 at 90 degrees out of phase with transducer 1. The graphs 2100, 2120 show the large errors introduced by coupling: the amplitude is out of phase with drive input in graph 2100 and causes massive phase errors in graph 2120. The graphs 2150, 2170 show the control possible with feed-forward coupled control, with amplitude accuracy better than 1% in graph 2140 and phase under tight control except near zero-output in graph 2160.

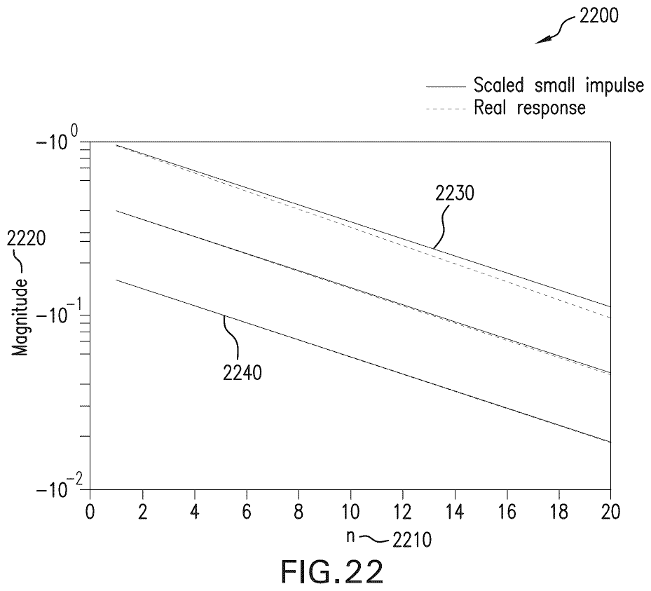

FIG. 22 shows a graph 2200 of simulations of a nonlinear response for impulse response amplitude of a standard damped oscillator and a damped harmonic oscillator with a nonlinear damping term. The x-axis 2210 is n. The y-axis 2220 is magnitude. The plots 2230, 2240 represent the amplitude decay of a resonant system starting at the amplitude given at the start of the curve (x-axis 2210 value 1). The scaled small impulse plot 2230 show a response where decay is exponential (simply proportional to amplitude) and hence is a straight line on a semi-log plot which is expected from a simple damped oscillator. In this case the impulse response can simply be scaled by the starting value. The real response plot 2240 show the response of a nonlinear system where the decay of the amplitude is a stronger with higher amplitude and thus deviates more from the simple system when drive is high. The method presented in equation 2 uses the full range of impulse response curves produced by different starting amplitudes to work out a correct historical term and more accurately drive the system.

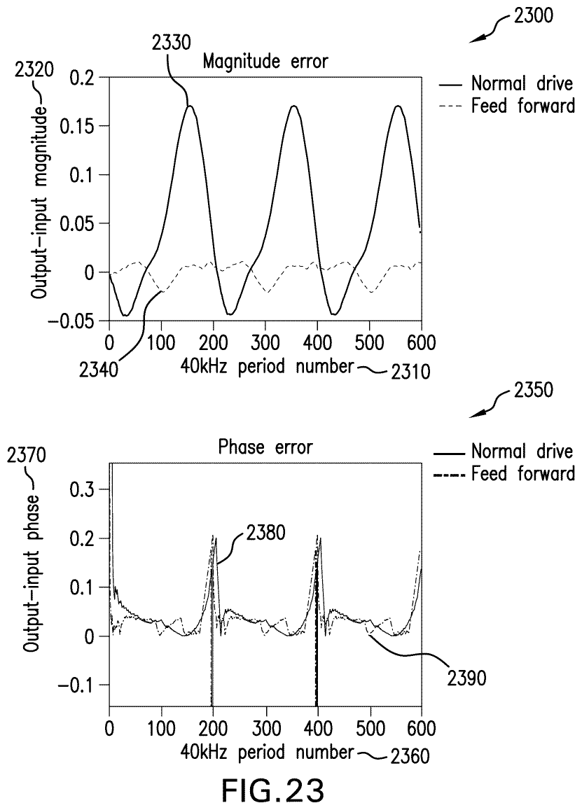

FIG. 23 show graphs 2300, 2350 of amplitude and phase accuracy of amplitude-modulated input using regular and feed-forward drive applied to a real-world 40 kHz transducer model including a nonlinear damping term. The x-axes 2310, 2360 are the 40 kHz period number. The y-axis 2320 of the first graph 2300 is output-input magnitude. The y-axis 2370 of the second graph 2350 is output-input phase. The plot shows normal 2330, 2380 and feed forward 2340, 2390 drive. Amplitude modulation desired is 200 Hz and full modulation amplitude. Input coefficients are converted to a PWM signal with 100 steps per period to simulate real-world digital drive. In the case of the normal drive, the input amplitude is adjusted to match the nonlinear response curve in the steady state, and this corrected response is what is used to calculate the difference from output. In the case of the feed-forward control, the input signal was scaled so that an input of 1 corresponded to the maximum the transducer model was capable of producing (in this case ˜0.77). Information regarding the shape of the nonlinearity is contained in the impulse response functions and will automatically fix the curve shape. As with linear systems, the feed-forward control is able to control the system with better accuracy than traditional methods.

### II. Additional Disclosure

There is quite a bit of text spent comparing the feed-forward method to current (steady-state) methods.

Feedback control designs require sampling at the system which increases cost and complexity.

One inventive step lies in recognizing that the impulse response for a highly-resonant system can be approximated by Fourier components at the resonant frequency (equation 2). This key simplification reduces the deconvolution operator to matrix algebra. Beyond this, manipulating the impulse response to be a function of drive amplitude to compensate for amplitude non-linearities is novel. Also, adapting this to a coupled resonant-system array and solving for the necessary drive as a matrix inversion is new.

Additional disclosure is as follows:
15. A method comprising:
generating a drive amplitude and phase of a resonant system to substantially realize a desired drive amplitudes and phases, wherein the resonant system comprises an impulse response of the resonant system, a history of drive phases and amplitudes, and a desired output;
reducing the impulse response to Fourier components at the resonant system's resonant frequency to create a reduced-form impulse response;
using the reduced-form impulse response and the history of drive phases and amplitudes to create a predicted current state of the resonant system;
using the reduced-form impulse response, the predicted current state of the resonant system, and the desired output to generate a final drive amplitude and a final phase.
16. The method as in claim 15, wherein the impulse response used changes in response to at least one of historical drive data, predicted drive data, temperature, age, altitude, external sensors and simulations.
17. The method as in claim 15, wherein the reduced-form impulse response, the predicted current state of the resonant system, and the desired output to generate the final drive amplitude and the final phase using an equation:

$${D}_{0} = ( {V}_{0} - ( D \cdot h ) ) / {h}_{0} . ;$$

where V₀ represents desired output, D₀ represents calculated final amplitude and phase, h₀ represents a first-period impulse response Fourier component, D is a vector containing time-shifted historical driving values, and h is a second vector containing time-shifted impulse response Fourier components.
18. The method as in claim 15, wherein the desired drive amplitudes and phases are filtered to reduce audio generation.
19. The method as in claim 15, wherein the final drive amplitude and the final drive phase is realized as a digital signal.
20. The method as in claim 15, wherein the final drive amplitude and the final drive phase is realized as an analog signal.
21. The method as in claim 15, wherein the impulse response is computed recursively, subject to a limit.
22. The method as in claim 15, wherein the resonant system measures the impulse response occasionally to adjust stored values.
23. The method as in claim 15, wherein the resonant system comprises multiple sub-elements, each which are individually addressed.
24. The method as in claim 23, wherein the resonant system comprises:
an array composed of impulse responses of coupled sub-elements;
the history of drive phases and amplitudes is a list of historical drive signals to each of the coupled sub-elements;
the desired output is a list of desired outputs for each of the coupled sub-elements; and
the desired drive amplitude and phase is a list of outputs for each of the sub-elements.
25. The method as in claim 24, wherein an array of the reduced-form impulse response Fourier components, a first list of the predicted current states of each sub-element, and a second list of the desired output of each sub-element generate a third list of the calculated drive amplitudes and phases using an equation:

$$\begin{matrix}{D}_{0} = {h}_{0}^{- 1} ( V - ( {h}_{1} {h}_{2} … {h}_{n} ) ( \begin{matrix}{D}_{1} \\ {D}_{2} \\ ⋮ \\ {D}_{n}\end{matrix} ) ) ; \\ where V = ( \begin{matrix}{V}_{1} \\ ⋮ \\ {V}_{m}\end{matrix} ) , {h}_{n} = ( \begin{matrix}{h}_{11 n} & {h}_{21 n} & … & {h}_{m 1 n} \\ {h}_{21 n} & {h}_{22 n} & ⋱ & ⋮ \\ ⋮ & ⋱ & ⋱ & ⋮ \\ {h}_{m 1 n} & … & … & {h}_{mmn}\end{matrix} ) , {D}_{n} = ( \begin{matrix}{D}_{1 n} \\ ⋮ \\ {D}_{mn}\end{matrix} ) , n\end{matrix}$$

represents a given period delay offset, numbered indexes in

$${h}_{n} = ( \begin{matrix}{h}_{11 n} & {h}_{21 n} & … & {h}_{m 1 n} \\ {h}_{21 n} & {h}_{22 n} & ⋱ & ⋮ \\ ⋮ & ⋱ & ⋱ & ⋮ \\ {h}_{m 1 n} & … & … & {h}_{mmn}\end{matrix} )$$

are impulse response Fourier components on a sub-element specified by the second number when a sub-element represented by the first number is driven and

$${h}_{0}^{- 1}$$

is an inverse of the first-cycle matrix of the impulse response array; Dₙ is the time-shifted historical drive values for each of m sub-elements; and
wherein an output of the equation (Do) is a list of driving coefficients for m sub-elements given a desired m outputs in V.

### (3). Conclusion

While the foregoing descriptions disclose specific values, any other specific values may be used to achieve similar results. Further, the various features of the foregoing embodiments may be selected and combined to produce numerous variations of improved haptic systems.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method comprising:
creating haptic feedback using ultrasound comprising the steps of:
producing an acoustic field from a transducer array having known relative positions and orientations;
defining a focus point having a known spatial relationship relative to the transducer array defining a path having a known spatial relationship relative to the transducer array in which the focus point will translate;
moving the focus point near the path so as to produce little audible sound.

2. The method as in claim 1, further comprising:
moving the focus point near the path in a method selected to produce a smooth phase function for a transducer.

3. The method as in claim 1 wherein the focus point moves near the path to produce a phase function with reduced high-frequency content for a transducer.

4. The method as in claim 1, wherein the focus point moves near the path so as to produce a smooth radius versus time from a transducer.

5. The method as in claim 1, wherein the focus point moves so that it spends more time near locations in the curve with tight curvature or end points.

6. The method as in claim 1 wherein the path is filtered to reduce high-frequency spatial content.

7. The method as in claim 1 wherein the path is approximated by approximation functions using a second path with reduced high-frequency content.

8. The method as in claim, 1 wherein the path is subdivided into multiple focal points.

9. The method as in claim 8, wherein the multiple focal points are distributed along the path to produce a smooth phase function for a transducer.

10. The method as in claim 8, wherein the multiple focal points are distributed along the path to produce a phase function with reduced high-frequency content for a transducer.

11. The method as in claim 8, wherein the multiple focal points are distributed along the path so as to produce a smooth radius versus time from a transducer.

12. The method as in claim 8, wherein the multiple focal points are distributed along the path such that the multiple focal points are more closely distributed at locations with tight curvature or end points.

13. The method as in claim 8, wherein spatial locations of the multiple focal points are filtered to remove high-frequency content.

14. The method as in claim 8, wherein the path is approximated by approximation functions using functions with reduced high-frequency content.

15. A method comprising:
generating a drive amplitude and phase of a resonant system to substantially realize a desired drive amplitudes and phases, wherein the resonant system comprises an impulse response of the resonant system, a history of drive phases and amplitudes, and a desired output;
reducing the impulse response to Fourier components at the resonant system's resonant frequency to create a reduced-form impulse response;
using the reduced-form impulse response and the history of drive phases and amplitudes to create a predicted current state of the resonant system;
using the reduced-form impulse response, the predicted current state of the resonant system, and the desired output to generate a final drive amplitude and a final phase.

16. The method as in claim 15, wherein the impulse response used changes in response to at least one of historical drive data, predicted drive data, temperature, age, altitude, external sensors and simulations.

17. The method as in claim 15, wherein the reduced-form impulse response, the predicted current state of the resonant system, and the desired output to generate the final drive amplitude and the final phase using an equation:
$${D}_{0} = ( {V}_{0} - ( D \cdot h ) ) / {h}_{0} . ;$$
where V₀ represents desired output, D₀ represents calculated final amplitude and phase, h₀ represents a first-period impulse response Fourier component, D is a vector containing time-shifted historical driving values, and h is a second vector containing time-shifted impulse response Fourier components.

18. The method as in claim 15, wherein the desired drive amplitudes and phases are filtered to reduce audio generation.

19. The method as in claim 15, wherein the final drive amplitude and the final drive phase is realized as a digital signal.

20. The method as in claim 15, wherein the final drive amplitude and the final drive phase is realized as an analog signal.

21. The method as in claim 15, wherein the impulse response is computed recursively, subject to a limit.

22. The method as in claim 15, wherein the resonant system measures the impulse response occasionally to adjust stored values.

23. The method as in claim 15, wherein the resonant system comprises multiple sub-elements, each which are individually addressed.

24. The method as in claim 23, wherein the resonant system comprises:
an array composed of impulse responses of coupled sub-elements;
the history of drive phases and amplitudes is a list of historical drive signals to each of the coupled sub-elements;
the desired output is a list of desired outputs for each of the coupled sub-elements; and
the desired drive amplitude and phase is a list of outputs for each of the sub-elements.

25. The method as in claim 24, wherein an array of the reduced-form impulse response Fourier components, a first list of the predicted current states of each sub-element, and a second list of the desired output of each sub-element generate a third list of the calculated drive amplitudes and phases using an equation:
$$\begin{matrix}{D}_{0} = {h}_{0}^{- 1} ( V - ( {h}_{1} {h}_{2} … {h}_{n} ) ( \begin{matrix}{D}_{1} \\ {D}_{2} \\ ⋮ \\ {D}_{n}\end{matrix} ) ) ; \\ where V = ( \begin{matrix}{V}_{1} \\ ⋮ \\ {V}_{m}\end{matrix} ) , {h}_{n} = ( \begin{matrix}{h}_{11 n} & {h}_{21 n} & … & {h}_{m 1 n} \\ {h}_{21 n} & {h}_{22 n} & ⋱ & ⋮ \\ ⋮ & ⋱ & ⋱ & ⋮ \\ {h}_{m 1 n} & … & … & {h}_{mmn}\end{matrix} ) , {D}_{n} = ( \begin{matrix}{D}_{1 n} \\ ⋮ \\ {D}_{mn}\end{matrix} ) , n\end{matrix}$$
represents a given period delay offset, numbered indexes in
$${h}_{n} = ( \begin{matrix}{h}_{11 n} & {h}_{21 n} & … & {h}_{m 1 n} \\ {h}_{21 n} & {h}_{22 n} & ⋱ & ⋮ \\ ⋮ & ⋱ & ⋱ & ⋮ \\ {h}_{m 1 n} & … & … & {h}_{mmn}\end{matrix} )$$
are impulse response Fourier components on a sub-element specified by the second number when a sub-element represented by the first number is driven and
$${h}_{0}^{- 1}$$
is an inverse of the first-cycle matrix of the impulse response array; Dₙ is the time-shifted historical drive values for each of m sub-elements; and
wherein an output of the equation (D₀) is a list of driving coefficients for m sub-elements given a desired m outputs in V.
